(19) United States
(12) Patent Application Publication
(10) Pub. No.: US 2013/0100943 A1
(43) Pub. Date: Apr. 25, 2013

(54) DETECTING THE PRESENCE OF A PREAMBLE IN A RECEIVED WIRELESS SIGNAL

(71) Applicant: Ravishankar H. MAHADEVAPPA, San Jose, CA (US)

(72) Inventor: Ravishankar H. MAHADEVAPPA, San Jose, CA (US)

(73) Assignee: MEDIATEK SINGAPORE PTE. LTD., Singapore (SG)

(21) Appl. No.: 13/276,776

(22) Filed: Oct. 19, 2011

(51) Int. Cl. H04W 84/02

(52) U.S. Cl. 370/338

(57) ABSTRACT

Embodiments for processing signals are disclosed. In one embodiment, a method includes providing a plurality of cyclically shifted versions of a known sequence. The method also includes receiving a plurality of delayed versions of a received sequence of a packet. The method also includes correlating the plurality of the delayed versions of the received sequence with the plurality of cyclically shifted versions of the known sequence. The method also includes detecting a preamble of the packet based on the outcome of a described decision statistic computed using the received and known sequences.

### FIELD OF THE INVENTION

The present invention relates generally to WLAN receivers, and more particularly to receivers that require detection of and synchronization to preambles in packets.

### BACKGROUND

Transmissions in a wireless local area network (WLAN) are packet based, where each packet has a preamble that needs to be detected in order for a WLAN device to properly process the packet. A main problem in packet detection is detecting the start of the packet. Conventional methods of packet detection include auto-correlation and cross-correlation. These conventional methods are not robust in all operating conditions. For example, the auto-correlation method is not reliable at low signal-to-noise ratio (SNR) values (e.g., close to 0 dB), because the noise overpowers the received signal. Also, the auto-correlation method does not provide an accurate start-of-preamble timing estimate even at high SNR values. The cross-correlation method fails to work in multipath environments, because the cross-correlation method fails to coherently combine distributed energy. Most conventional receivers use a combination of the above two methods, where the cross-correlation method is used to obtain an accurate start-of-preamble timing estimate, and where the autocorrelation method is used to detect the presence of preambles in multipath environments.

Accordingly, what is desired is an improved method and system for detecting the presence of a preamble of a packet. The system and method should be easily implemented, cost effective, reliable, and should be adaptable to existing communications systems. Embodiments described herein address such a need.

### SUMMARY

A method, system, and computer readable medium for detecting the presence of a preamble of a packet are disclosed. In one aspect, a method includes providing a plurality of cyclically shifted versions of a known sequence of complex numbers. The method also includes receiving a plurality of delayed versions of a received complex number sequence of a packet. The method also includes correlating the plurality of the delayed versions of the received sequence with the plurality of cyclically shifted versions of the known sequence. The method also includes detecting a preamble of the packet based on the correlating.

In another embodiment, a system includes at least one filter for receiving a plurality of delayed versions of a received sequence of a packet. The system also includes a preamble detector. The preamble detector provides a plurality of cyclically shifted versions of a known sequence of complex numbers; correlates the plurality of the delayed versions of the received sequence with the plurality of cyclically shifted versions of the known sequence; and detects a preamble of the packet based on the correlating.

### BRIEF DESCRIPTION OF THE DRAWINGS

FIG. 1 is a block diagram of a first embodiment of a receiver circuit in accordance with the present invention.

FIG. 2 is a block diagram of a second embodiment of a receiver circuit in accordance with the present invention.

FIG. 3 is a flow chart which illustrates a method for detecting the presence of a preamble of a packet in accordance with an embodiment of the present invention.

### DETAILED DESCRIPTION

The present invention relates generally to WLAN receivers, and more particularly to receivers that require detection of and synchronization to preambles in packets. The following description is presented to enable one of ordinary skill in the art to make and use embodiments of the invention, and is provided in the context of a patent application and its requirements. Various modifications to the embodiments and the generic principles and features described herein will be readily apparent to those skilled in the art. Thus, embodiments of the present invention are not intended to be limited to the examples shown, but are to be accorded the widest scope consistent with the principles and features described herein.

Embodiments provide a robust and efficient method and system for detecting the presence of preambles of 802.11a/b/g/n/ac packets in a given set of received samples of WLAN transmissions. As described in more detail below, a plurality of cyclically shifted versions of a known sequence of complex numbers is provided. A preamble detector receives a plurality of delayed versions of a received complex numbers sequence of a packet, and then correlates the plurality of the delayed versions of the received sequence with the plurality of cyclically shifted versions of the known sequence. The preamble detector then detects a preamble of the packet based on the outcome of a described decision statistic computed using the received and known sequences.

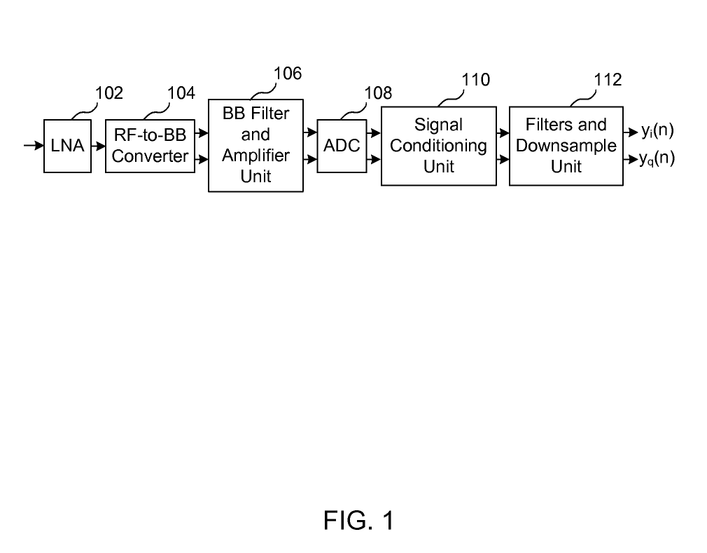

FIG. 1 is a block diagram of a first embodiment of a receiver circuit in accordance with the present invention. As shown, the receiver circuit includes a low-noise amplifier (LNA) 102 that receives transmission signals from an antenna. The LNA 102 is coupled to a radio frequency (RF)-to-baseband (BB) converter 104. The RF-to-BB converter 104 is coupled to a BB filter and amplifier unit 106. The BB filter and amplifier unit 106 is coupled to an analog-to-digital converter (ADC) 108, which outputs discrete-time, digital outputs. In an example implementation, the output sample rate of the ADC 108 may be a multiple of 20 MHz. The ADC 108 is coupled to a signal conditioning unit 110, which performs various signal conditioning processes. The signal conditioning unit 110 is coupled to a filter and downsample unit 112. In an example implementation, the output sample rate of the filter and downsample unit 112 may be 20 MHz. The output of the filter and downsample unit 112 is used for preamble detection, which is described in more detail below. In a two receiver (RX) chain (described below), there is a second such receiver chain that generates another set of samples for each time index.

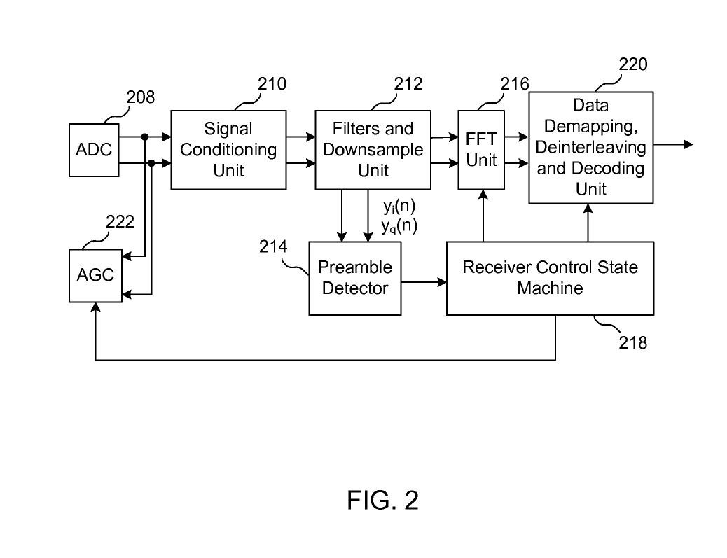

FIG. 2 is a block diagram of a second embodiment of a receiver circuit in accordance with the present invention. As shown, the receiver circuit includes an ADC 208 that performs analog-to-digital conversions of transmission signals. The ADC 208 is coupled to a signal conditioning unit 210, which performs various signal conditioning processes. The signal conditioning unit 210 is coupled to a filter and downsample unit 212. The filter and downsample unit 212 is coupled to a preamble detector 214. In various embodiments, the preamble detector 214 provides a binary output that indicates the start of a preamble in the received samples of a transmission signal. The operation of the preamble detector 214 is described in more detail below.

The preamble detector 214 is coupled to a receiver control state machine 218. The receiver control state machine 218 is coupled to a fast Fourier transform (FFT) unit 216 and to a data demapping, deinterleaving and decoding unit 220, and to an automatic gain controller (AGC) 222. The ADC 208 is also coupled to the AGC 222. In one embodiment, the information at the output of the preamble detector 214 is used by the receiver control state machine 218 to orchestrate further processing of the received samples by the FFT unit 216, and the data demapping, deinterleaving and decoding unit 220.

According to the IEEE 802.11n standard, WLAN receivers need to be able to detect and decode both orthogonal frequency-division multiplexing (OFDM) (802.11a/g/n) and direct-sequence spread spectrum (DSSS) (802.11b) packets in order to support older devices operating in a network. The 802.11b packets have a preamble that is made up of a binary sequence spread by a Barker sequence of length 11 samples transmitted at 11 MHz chip rate. The OFDM packets of 802.11a/g use repetitions of a short training sequence (STF) of length 16 samples transmitted at MHz. In an 802.11n packet, the STF sequences may additionally be shifted in time by several samples and transmitted over a maximum of 4 antennas.

The following is an example of an 802.11a/b preamble structure:

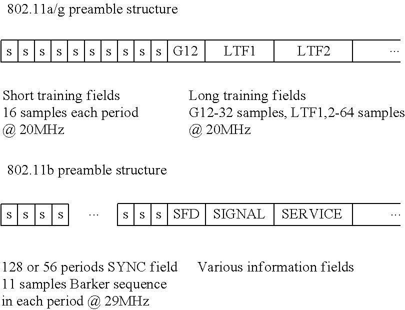

Successful preamble detection is a fundamental requirement in effective data communication, as failures lead to loss of data packets, resulting in inefficient use of bandwidth and delays in communication. Furthermore, because a WLAN device is continuously scanning for transmissions even when the WLAN device is not transmitting, it is important that the WLAN device use a robust and efficient method to detect different preamble variants.

Waveform detection is a classic problem in detection theory. Several methods may be formulated based on information available and differing channel conditions. Typically, the problem is defined as one of distinguishing between two hypotheses: H₀ is where the received samples do not contain a preamble, and H₁ is where the received samples have a linearly transformed preamble with some additive noise. In various embodiments, a decision rule is formulated where a function of the received samples T(yₙ), called the decision statistic, is compared with a threshold to decide in favor of hypothesis H₁. The following is an example of a decision rule:

Declare H₁ true if T (yₙ)>λ, where λ:Pr(decide H₁|H₀ is true)=P_{fa}.

In one embodiment, the threshold λ may be chosen to limit the probability of false alarms Pr(decide H₁|H₀) to a desired constant P_{fa}. In one embodiment, when the threshold λ is set too high, the probability of false alarms is greatly reduced, but the detector may also miss a large number of packets. On the other hand, if the threshold λ is set too low, the receiver may be continuously triggered by false alarms and may still miss good data packets while processing false alarms. Therefore, the threshold λ needs to be tuned carefully to meet a reasonable target probability of false alarms P_{fa} and to meet a target probability of correct detection P_{cd} for the range of SNRs over which the device is expected to operate.

Autocorrelation and Cross-Correlation

The conventional methods used in WLAN preamble detection are autocorrelation and cross-correlation. In autocorrelation, the receiver uses knowledge of the fact that the preamble consists of repeated sequences, and correlates the received samples with a delayed version to obtain the following autocorrelation output:

$$a c ( n ) = {\vert {\sum }_{k = 0}^{{N}_{pre} - 1} {y}_{n - k - {N}_{pre}}^{†} {y}_{n - k} \vert}^{2} ,$$

An energy estimate is also computed using the following equation:

$$e e ( n ) = {\sum }_{k = 0}^{{N}_{pre} - 1} {\vert {y}_{n - k} \vert}^{2} ,$$

The following decision rule is formulated:

Declare preamble found if ac(n)>ee(n)*λ_{ac}, where λ_{ac} is a suitably chosen threshold.

In cross-correlation, the receiver correlates the received samples yₙ with the known expected sequence sₖ, according to the following equation:

$$c c ( n ) = {\vert {\sum }_{k = 0}^{{N}_{pre} - 1} {s}_{k}^{†} {y}_{n - {N}_{pre} + 1 + k} \vert}^{2} ,$$

and along with the energy estimate and the 2-norm of sequence sₖ, using the following equation:

$$s s ( n ) = {\sum }_{k = 0}^{{N}_{pre} - 1} {\vert {s}_{k} \vert}^{2} ,$$

which formulates the decision rule:
Declare preamble found if cc(n)>ee(n)*ss*λ_{cc},
   with an appropriately chosen λ_{cc}.

Extensions to Cross-Correlation

Embodiments described herein provide detection methods which are derived by extending the simple cross-correlation method to handle multipath scenarios, multiple RX chains, and associated impairments such as gain/noise figure imbalances, cyclic shift diversity added in 802.11n mixed mode and Greenfield modes, and impairments such as DC offset, etc.

In various embodiments described herein, instead of computing a decision statistic based on a single cross-correlator output, a preamble detector computing a decision statistic based on a vector of multiple cross-correlator outputs over certain windows (e.g., 4-8 windows).

Extensions to the cross-correlation method described herein provide improved detection of preambles in packets received by a receiver, even where the received packets have various impairments due to a multipath channel and an imperfect analog front-end.

In various embodiments, computation of the decision statistic is reframed using the following equation:

$$Let {T}_{cc} ( {y}_{n} ) = \frac{{y}_{n}^{†} {s ( {s}^{†} s )}^{- 1} {s}^{†} {y}_{n}}{{y}_{n}^{†} {y}_{n}} , where s = [ \begin{matrix}{s}_{0} \\ {s}_{1} \\ ⋮ \\ {s}_{{N}_{pre - 1}}\end{matrix} ]$$

$$and {y}_{n} = [ \begin{matrix}{y}_{n - {N}_{pre} + 1} \\ {y}_{n - {N}_{pre} + 2} \\ ⋮ \\ {y}_{n}\end{matrix} ] .$$

In one embodiment, matrix s includes a known complex sequence (e.g., s₀, s₁, . . . s_{Npre}), and matrix yₙ includes a received complex sequence (e.g., y_{n-Npre+1}, y_{n-Npre+2}, . . . yₙ). The length of a given vector is Nₚᵣₑ. In one embodiment, a decision rule may be formulated as follows:

Declare [symbol] ₁ true if T_{cc}(yₙ)>λ_{cc}

Note that the correlation cc may be expressed as s^{†}yₙ, and the norm ss may be replaced by s^{†}s and energy estimate ee is given by s^{†}yₙ, where the symbol † is the conjugate transpose.

Multipath Channels

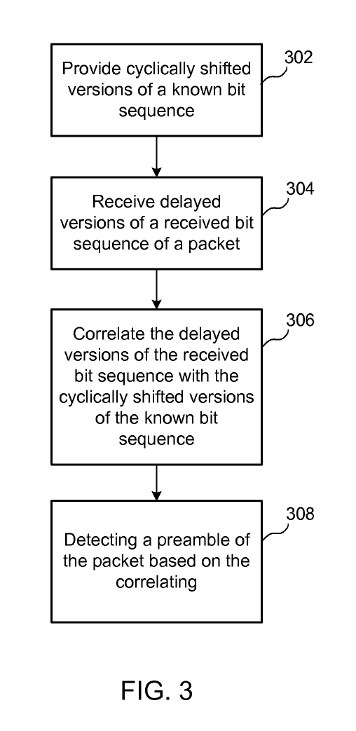

FIG. 3 is a flow chart which illustrates a method for detecting the presence of a preamble of a packet in accordance with an embodiment of the present invention. Referring to FIGS. 2 and 3 together, first, the preamble detector 214 provides cyclically shifted versions of a known sequence of complex numbers, via step 302. Next, the preamble detector 214 receives delayed versions of a received complex number sequence of a packet in a transmitted signal, via step 304. In various scenarios, the multiple delayed versions of the received sequence are due to reflections from various objects in the environment.

The preamble detector 214 then correlates the delayed versions of the received sequence with the cyclically shifted versions of the known sequence, via step 306. In one embodiment, as a part of the correlating step, the preamble detector 214 computes a decision statistic. In one embodiment, the preamble detector 214 generates a first matrix that includes the cyclically shifted versions of the known sequence, and generates a second matrix that includes the delayed versions of the received sequence.

As indicated above, the receiver receives multiple delayed versions of the received sequence due to reflections from various objects in the environment. In one embodiment, in order to coherently combine the reflections, the preamble detector 214 computes the decision statistic using the following equation:

$$T ( {y}_{n} , X ) = \frac{{y}_{n}^{†} {X ( {X}^{†} X )}^{- 1} {X}^{†} {y}_{n}}{{y}_{n}^{†} {y}_{n}} , \\ where$$

$$X = [ \begin{matrix}{s}_{0} & {s}_{1} & … & {s}_{L - 1} \\ {s}_{1} & {s}_{2} & … & {s}_{L} \\ ⋮ & ⋮ & ⋱ & ⋮ \\ {s}_{{N}_{pre}} & {s}_{0} & … & {s}_{L - 2}\end{matrix} ] .$$

In one embodiment, T (yₙ, X) is the decision statistic, and X is a matrix (matrix X) that is formed by cyclically shifted versions of a known sequence s.

As shown, instead of computing a decision statistic based on a single cross-correlator output (e.g., s), the preamble detector computes the decision statistics based on a vector of multiple cross-correlator outputs (e.g., s₀, s₁, . . . s_{Npre}) over a certain window (e.g., 4 samples, 8 samples, etc.). The first column shows a sequence s₀, s₁, . . . s_{Npre}, with so at the top and s_{Npre} at the bottom. The second column shows the same sequence that is shifted, with s₁ at the top and s₀ at the bottom. The remaining columns exhibit the same cyclically shifting pattern, and so on until the last column on the right, with s_{L-1} at the top and s_{L-2} at the bottom. L is a predetermined variable. For example, if L=1, the matrix X reduces to the vector s. In various embodiments, a typical value for L is 4. In this specific example embodiment, each successive column to the right is shifted up relative to the immediate column to the left. In other embodiments, each successive column to the right may be shifted down relative to the immediate column to the left.

Next, the preamble detector 214 detects a preamble of the packet based on the correlating, via step 308. In one embodiment, to detect the preamble, the preamble detector 214 compares the decision statistic with a predetermined threshold, and then determines that the received sequence includes the preamble if the decision statistic is greater than the predetermined threshold.

802.11n Mixed Mode and Greenfield Mode Packets

Embodiments disclosed herein may be used to also process 802.11n mixed mode packets and Greenfield mode packets. In one embodiment, the method of FIG. 3 is implemented, as described above, except that the known sequence is cyclically shifting based on predetermined fixed delays.

In various embodiments, the preamble of particular packets (e.g., 802.11n mixed mode packets and Greenfield mode packets) are shifted by certain fixed delays at the transmitter prior to transmission on multiple antennas. Typical cyclic shift delay values are provided in the IEEE 802.11n standard.

In one embodiment, matrix X may be generalized to receive such packets as follows:

$$X = [ \begin{matrix}{s}_{0} & {s}_{{n}_{1}} & … & {s}_{{n}_{k}} \\ {s}_{1} & {s}_{{n}_{1} + 1} & … & {s}_{{n}_{k} + 1} \\ ⋮ & ⋮ & ⋱ & ⋮ \\ {s}_{{N}_{pre} - 1} & {s}_{{n}_{1} - 1} & … & {s}_{{n}_{k} - 1}\end{matrix} ] .$$

In matrix X above, the first column shows a sequence s₀, s₁, . . . s_{Npre-1}, with s₀ at the top and s_{Npre-1} at the bottom. The second column shows the same sequence that is shifted, with sₙ₁ at the top and sₙ₁-1 at the bottom. The remaining columns exhibit the same cyclically shifting pattern, and so on until the last column, with sₙₖ at the top and Sₙₖ₋₁ at the bottom.

In one embodiment, n₁, . . . , nₖ are cyclic shift delays/values in a number of samples at 20 MHz. Multiple matrices/detectors may be formed by using different shift values for n₁, . . . , nₖ. The value for n₁ may vary depending on the specific implementation, which will depend on the particular packets to be detected. For example, if in a given matrix X₁, where n₁=4, each successive column to the right is shifted up by 4 relative to the immediate column to the left.

Typical values for multiple matrices are shown in the table below, where Xₙ is a particular matrix, k is a column count (e.g., column 0, column 1, column 3, etc.), and nₙ is a shift index for a particular column.

| Matrix | k | Shift Index | Shift Value |
|---|---|---|---|
| X₁ | 0 | | |
| X₂ | 1 | n₁ | 4 |
| X₃ | 2 | (n₁, n₂) | (2, 4) |
| X₄ | 3 | (n₁, n₂, n₃) | (1, 2, 3) |
| X₅ | 1 | n₁ | 8 |
| X₆ | 2 | (n₁, n₂) | (4, 8) |
| X₇ | 3 | (n₁, n₂, n₃) | (4, 8, 12) |

In one embodiment, multiple matrices (e.g., any combination of matrix X₁ through matrix X₇) may be used to detect preambles in a packet, where each matrix used provides an additional decision statistic for detecting preambles. In one embodiment, a decision rule may be formulated by combining the decision statistics corresponding to the above matrices as follows:
Declare [symbol] ₁ true if: ORᵢ₌₁⁷T(yₙ,Xᵢ)>λᵢ

Sensitivity Enhancement By Combining Two Periods

Embodiments disclosed herein also enhance detection sensitivity. For example, in one embodiment, during the correlating step, the preamble detector 214 combines at least two periods of a repeated training sequence associated with the received sequence.

Combining periods of repeating training sequences improves performance for all channel conditions. In one embodiment, preamble detector 214 may compute the decision statistic using the following equation:

$${T}_{2} ( {y}_{n} , X ) = \frac{{P}_{n} + {P}_{n - {N}_{pre}}}{{E}_{n} + {E}_{n - {N}_{pre}}} ;$$

where Pₙ=yₙ^{†}X(X^{†}X)⁻¹X^{†}yₙ, Eₙ=yₙ^{†}yₙ.

In one embodiment, T₂ (yₙ, X) is the decision statistic, where each additional term in the numerator and the denominator represents an additional training sequence having a different time index. For example, the second terms of numerator and denominator (e.g., P_{n-Npre}, E_{n-Npre}) are delayed versions of the first terms (e.g., Pₙ, Eₙ). This enables an averaging of multiple training sequences in order to address different noise phenomena introduced during different time periods. This averaging results in better decisions when detecting preambles.

Multiple Receiver (RX) Chains

Embodiments described herein may also be applied to multiple RX chains. In one embodiment, the preamble detector 214 may combine metrics computed for each RX chain in order to make a single decision. For example, in one embodiment, to compute the decision statistic, the preamble detector 214 may compute a first chain decision statistic, compute a second chain decision statistic, and then combine the first chain decision statistic and the second chain decision statistic.

In one embodiment, the preamble detector 214 may compute the decision statistic using the following equation:

$${T}_{2} ( {y}_{n , 0} , {y}_{n , 1} , X ) = \frac{{a}_{0} ( {P}_{n , 0} + {P}_{n - {N}_{pre} , 0} ) + {a}_{1} ( {P}_{n , 1} + {P}_{n - {N}_{pre} , 1} )}{{a}_{0} ( {E}_{n , 0} + {E}_{n - {N}_{pre} , 0} ) + {a}_{1} ( {E}_{n , 1} + {E}_{n - {N}_{pre} , 1} )} .$$

In one embodiment, T₂ (yₙ, 0, y_{n,1}, X) is the decision statistic, and scaling factors a₀ (corresponding to a first RX chain) and a₁ (corresponding to a second RX chain) may be used to compensate for differences in initial gain and noise figure of the two chains. In various embodiments, the noise figure is an indication of the amount of noise added while a signal is being processed by the RF front end.

Direct Current (DC) Offset Compensation

Embodiments described herein also perform DC offset compensation. The DC component in the received sequences may affect the preamble determination by biasing the denominator when the numerator is computed using a zero-mean sequence s. To compensate, the energy in the DC component is computed separately and subtracted out from the total energy term Eₙ. For example, in one embodiment, during the correlating step, the preamble detector 214 may compute an energy value, compute a sub-energy value associated with a direct current component of the signal, and then subtract the sub-energy value from the energy value.

In one embodiment, the preamble detector 214 may perform DC offset compensation using the following equation:

$${\hat{E}}_{n} = {E}_{n} \dot{-} {( \frac{1}{{N}_{pre}} {\sum }_{i = 0}^{{N}_{pre} - 1} {y}_{n - i} )}^{2} .$$

The detection methods described herein presume a known sequence s. In practice, this known sequence is a scaled and quantized version of certain sequences specified in the IEEE 802.11 standard. In one embodiment, to detect an orthogonal frequency-division multiplexing (OFDM) packet that is transmitted according to 802.11a/g/n, a short training field may be used. In one embodiment, to detect 802.11b packets, a Barker sequence may be used. Furthermore, these sequences may be resampled at a different frequency to suit various implementation requirements. For example, an original 11-sample long Barker sequence specified in the standards may be resampled to derive a 20-sample long sequence at 20 MHz.

Embodiments described herein may be used to detect the end of GI2 field in 802.11a/g/n packets, by using a scaled and quantized version of the known transmitted guard interval (GI2) field sequence specified by the IEEE 802.11 standard as s. The length of the sequence in this particular example will be 32 samples at 20 MHz sampling frequency.

Embodiments disclosed herein provide numerous benefits. For example, implementations of the embodiments described herein are very robust. Embodiments may operate at very low SNRs where traditional autocorrelation detectors fail. Embodiments can handle multipath channel effects better than cross-correlation detectors. Embodiments also combine information from multiple receive chains to arrive at a decision on the presence of a packet.

A method and system for detecting the presence of a preamble of a packet has been disclosed. Embodiments described herein can take the form of an entirely hardware implementation, an entirely software implementation, or an implementation containing both hardware and software elements. Embodiments may be implemented in software, which includes, but is not limited to, application software, firmware, resident software, microcode, etc.

The steps described herein may be implemented using any suitable controller or processor, and software application, which may be stored on any suitable storage location or computer-readable medium. The software application provides instructions that enable the processor to cause the receiver to perform the functions described herein.

Furthermore, embodiments may take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include DVD, compact disk-read-only memory (CD-ROM), and compact disk-read/write (CD-RAN).

Although the present invention has been described in accordance with the embodiments shown, one of ordinary skill in the art will readily recognize that there could be variations to the embodiments, and those variations would be within the spirit and scope of the present invention. Accordingly, many modifications may be made by one of ordinary skill in the art without departing from the spirit and scope of the appended claims.

What is claimed is:

1. A method comprising:
providing a plurality of cyclically shifted versions of a known sequence;
receiving a plurality of delayed versions of a received sequence of a packet;
correlating the plurality of the delayed versions of the received sequence with the plurality of cyclically shifted versions of the known sequence; and
detecting a preamble of the packet based on the correlating.

2. The method of claim 1, wherein the correlating comprises computing a decision statistic and wherein the preamble detecting comprises:
comparing the decision statistic with a predetermined threshold; and
determining that the received sequence includes the preamble if the decision statistic is greater than the predetermined threshold.

3. The method of claim 1, wherein the correlating comprises:
forming a first matrix of the cyclically shifted versions of the known sequence; and
forming a second matrix of the delayed versions of the received sequence.

4. The method of claim 1, wherein the generating comprises cyclically shifting the known sequence based on predetermined fixed delays.

5. The method of claim 1, wherein the correlating comprises combining at least two periods of a repeated training sequence associated with the received sequence.

6. The method of claim 1, wherein the correlating comprises computing a decision statistic, and wherein the decision statistic computing comprises:
computing a first chain decision statistic;
computing a second chain decision statistic; and
combining the first chain decision statistic and the second chain decision statistic.

7. The method of claim 1, wherein the correlating comprises:
computing an energy value;
computing a sub-energy value associated with a direct current component of the signal; and
subtracting the sub-energy value from the energy value.

8. A system comprising:
at least one filter for receiving a plurality of delayed versions of a received sequence of a packet; and
a preamble detector for:
providing a plurality of cyclically shifted versions of a known sequence;
correlating the plurality of the delayed versions of the received sequence with the plurality of cyclically shifted versions of the known sequence; and
detecting a preamble of the packet based on the correlating.

9. The system of claim 8, wherein the preamble detector further:
computes a decision statistic;
compares the decision statistic with a predetermined threshold; and
determines that the received sequence includes the preamble if the decision statistic is greater than the predetermined threshold.

10. The system of claim 8, wherein the preamble detector further:
forms a first matrix of the cyclically shifted versions of the known sequence; and
forms a second matrix of the delayed versions of the received sequence.

11. The system of claim 8, wherein the preamble detector further cyclically shifts the known sequence based on predetermined fixed delays.

12. The system of claim 8, wherein the preamble detector further combines at least two periods of a repeated training sequence associated with the received sequence.

13. The system of claim 8, wherein the preamble detector further:
computes a decision statistic;
computes a first chain decision statistic;
computes a second chain decision statistic; and
combines the first chain decision statistic and the second chain decision statistic.

14. The system of claim 8, wherein the preamble detector further:
computes an energy value;
computes a sub-energy value associated with a direct current component of the signal; and
subtracts the sub-energy value from the energy value.

15. A computer-readable medium including program instructions, the program instructions which when executed by a computer system cause the computer system to execute a method comprising:
providing a plurality of cyclically shifted versions of a known sequence;
receiving a plurality of delayed versions of a received sequence of a packet;
correlating the plurality of the delayed versions of the received sequence with the plurality of cyclically shifted versions of the known sequence; and
detecting a preamble of the packet based on the correlating.

16. The computer-readable medium of claim 15, further comprising program instructions for:
computing a decision statistic;
comparing the decision statistic with a predetermined threshold; and
determining that the received sequence includes the preamble if the decision statistic is greater than the predetermined threshold.

17. The computer-readable medium of claim 15, further comprising program instructions for cyclically shifting the known sequence based on predetermined fixed delays.

18. The computer-readable medium of claim 15, further comprising program instructions for combining at least two periods of a repeated training sequence associated with the received sequence.

19. The computer-readable medium of claim 15, further comprising program instructions for:
computing a first chain decision statistic;
computing a second chain decision statistic; and
combining the first chain decision statistic and the second chain decision statistic.

20. The computer-readable medium of claim 15, further comprising program instructions for:
computing an energy value;
computing a sub-energy value associated with a direct current component of the signal; and
subtracting the sub-energy value from the energy value.
